(19) United States
(12) Patent Application Publication
(10) Pub. No.: US 2011/0042373 A1
(43) Pub. Date: Feb. 24, 2011

(54) Erectable Platform for Microwave Heating of a Food Product

(75) Inventors: Giselle Monique Moses, Chicago, IL (US); Gary Herbert Carmichael, Des Plaines, IL (US); Paul Andrew Cogley, Gurnee, IL (US); Christopher Dunkle, Buffalo Grove, IL (US); Patrick A. Gowens, Libertyville, IL (US); Kathryn Hupfer, Chicago, IL (US); Bunlim Ly, Chicago, IL (US); Kenneth Pokusa, Darien, IL (US); David Allen Schroeder, Lombard, IL (US)

Correspondence Address: FITCH EVEN TABIN & FLANNERY, 120 SOUTH LASALLE STREET, SUITE 1600, CHICAGO, IL, 60603-3406, US

(73) Assignee: KRAFT FOODS GLOBAL BRANDS LLC, Northfield, IL (US)

(21) Appl. No.: 12/545,542

(22) Filed: Aug. 21, 2009

(51) Int. Cl. H05B 6/80

(52) U.S. Cl. 219/730

(57) ABSTRACT

Erectable platforms having microwave susceptors thereon are provided, where the platforms are convertible between a collapsed configuration and an erected configuration to save costs on packaging, storage, and shipping while still providing the benefits of elevated microwave heating. When the platforms are converted to the erected configurations, mechanisms are provided to maintain the platforms in the erected configuration.

### FIELD

This disclosure relates to a susceptor platform for microwave heating of a food product, and in particular an erectable susceptor platform for microwave heating of a food product.

### BACKGROUND

Various containers, sheets, and platforms have been used for microwave heating of food products. Susceptors may be disposed on at least part of these structures to at least partially absorb microwaves during microwave cooking to heat a food product disposed in close proximity to the susceptors, and in particular food products having dough-based components. U.S. Pat. No. 6,359,272 details some of the desirable properties of utilizing an elevated platform with a susceptor during microwave heating. For example, elevating the susceptor from the floor of a microwave creates an insulating air layer resulting in more heat to the food product. Also, if vents are provided in the elevated platform, moisture can vent below the platform reducing the potential for a soggy food product.

A permanently elevated platform provides ease of use to the consumer, who is not required to manipulate the platform to an elevated position prior to microwave heating. This creates a problem, however, when considering outer packaging for the platform. If the elevated platform is inserted below a food product, the outer packaging may have to be made larger to accommodate the elevated platform and the food product stacked onto each other. If the elevated platform is turned upside down, the food product may have to fit within the confines of the cavity of the elevated platform. Additionally, platforms have been disclosed that are configured to be erectable. These platforms, however, commonly involve numerous complicated locking tabs or other mechanisms, which can be undesirably difficult for a user and/or result in platforms that are not adequately supported or maintained in their elevated configurations. Accordingly, a platform that is convertible between a collapsed configuration and an elevated configuration is needed that still provides ease of use to the consumer.

### SUMMARY

An erectable susceptor platform for microwave heating of a food product is disclosed. The platform is convertible between a collapsed configuration and an erected configuration. This can advantageously permit shipping in the collapsed configuration, saving on packaging and shipping/storage costs, while still providing the benefits of elevated microwave heating. A user can take the erectable platform out of the outer packaging, such as a carton or wrapper, in its collapsed configuration and manipulate the legs to an erected position, generally about 90 degrees. The platform further includes mechanisms to maintain the platform in the erected configuration and restrict the platform from collapsing back to the collapsed configuration under the weight of the food product. Once the platform is maintained in the erected configuration, the food product can be placed on the platform and then heated in a microwave.

In one aspect, the erectable platform includes a support having opposing edge portions with a susceptor disposed thereon for microwave heating of the food product. The erectable platform also includes a pair of legs. One of the legs is connected to the support via a hinge adjacent one of the edge portions. The other of the legs is connected to the support via a hinge adjacent the other of the edge portions. Additionally, each of the legs has a segment configured to be inwardly movable about a hinge at a middle portion of the leg with an adjacent portion of the leg to a position beneath the support generally aligned with the segment of the other leg to contact an underside of the support across a middle portion thereof and maintain the platform in its erected configuration.

In a second aspect, the erectable platform includes the support with the opposing edge portions, the susceptor disposed on the support, and the legs connected to the support via the hinges adjacent the edge portions. In this aspect, each of the legs has at least one segment at an end thereof inwardly movable about a hinge with an adjacent portion of the leg to a position beneath the support and spaced from an edge of the support to contact an underside of the support and maintain the platform in its erected configuration.

In another aspect, the erectable platform includes the support with the opposing edge portions, the susceptor disposed on the support, and the legs connected to the support via the hinges adjacent the edge portions. In this aspect, the support includes a segment movable about a hinge with an adjacent portion of the support. The segment is configured to move to an interlocking position with one of the legs to maintain the platform in its erected configuration.

In a fourth aspect, the erectable platform includes the support with the opposing edge portions and the susceptor disposed on the support. The support is further free from structure above the susceptor such that it is generally planar and includes at least one slot adjacent each of the edge portions. The legs connect to the support via first hinges adjacent the edge portions. Additionally, the legs have a bottom edge and include a second hinge disposed between the first hinge and the bottom edge. So constructed, the legs are configured to fold about the first and second hinges. The legs are further configured to be insertable into an adjacent one of the slots of the support to secure the platform in its erected position. When the platform is in the erected configuration the legs depend therefrom and the platform is supported by the second hinge.

### BRIEF DESCRIPTION OF THE DRAWINGS

FIG. 1 is a perspective view of a first embodiment of an erectable platform for microwave heating of a food product in a collapsed configuration;

FIG. 2 is a perspective view of the erectable platform of FIG. 1 in an erected configuration showing a portion of the collapsed configuration in broken lines;

FIG. 3 is a perspective view of the erectable platform of FIG. 1 in the erected configuration with a cut-out showing detail of the interior of the erectable platform;

FIG. 4 is a perspective view of the erectable platform of FIG. 1 in the erected position supporting a food product;

FIG. 5 is a perspective view of the erectable platform of FIG. 1 showing the erectable platform in the collapsed configuration partially within outer packaging and supporting an individually-wrapped food product;

FIG. 6 is a top plan view of a blank of the erectable platform of FIG. 1;

FIG. 7 is a second embodiment of an erectable platform for microwave heating of a food product in an erected configuration;

FIG. 8 is a top plan view of a blank of the erectable platform of FIG. 7;

FIG. 9 is a perspective view of a third embodiment of an erectable platform for microwave heating of a food product in a collapsed configuration;

FIG. 10 is a perspective view of the erectable platform of FIG. 9 in an erected configuration showing a portion of the collapsed configuration in broken lines;

FIG. 11 is a front elevation view of the erectable platform of FIG. 9 in the erected configuration;

FIG. 12 is left side elevation view of the erectable platform of FIG. 9 in the erected configuration;

FIG. 13 is a top plan view of a blank of the erectable platform of FIG. 9;

FIG. 14 is a perspective view of a fourth embodiment of an erectable platform for microwave heating of a food product in an erected configuration;

FIG. 15 is a perspective view of a blank of the erectable platform of FIG. 14; and

FIG. 16 is a perspective view of the erectable platform of FIG. 14 in an erected configuration showing an alternative leg configuration.

### DETAILED DESCRIPTION

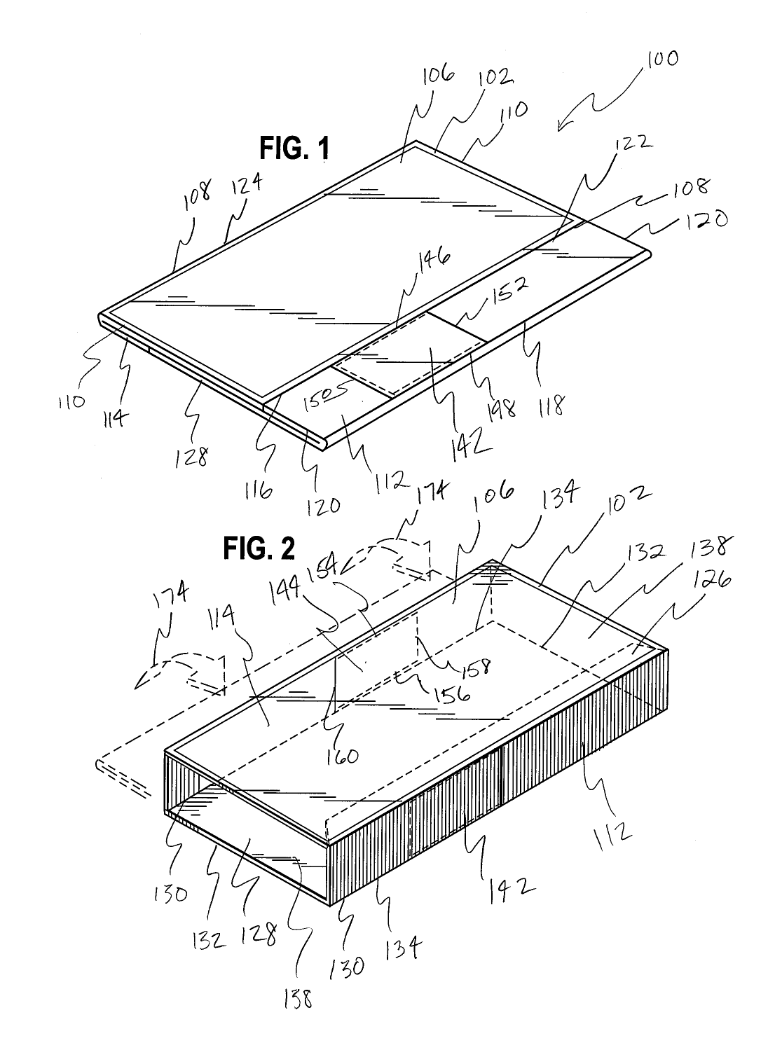

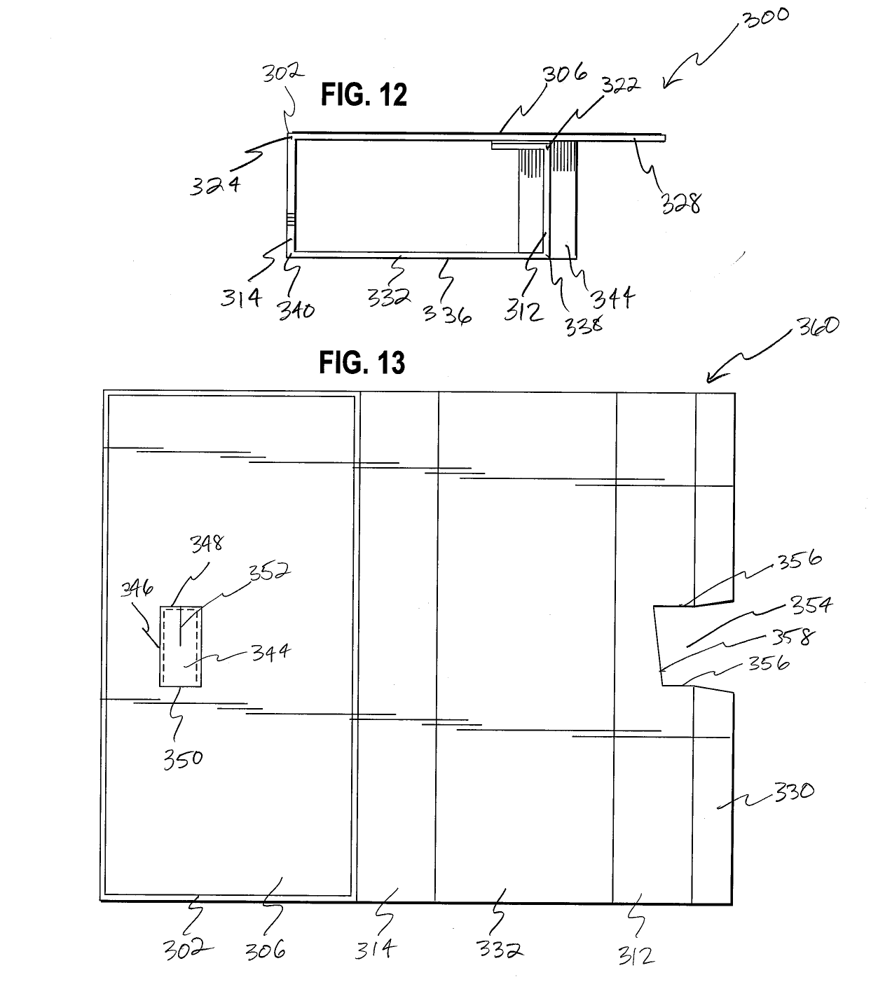

Exemplary embodiments of erectable platforms for microwave heating in accordance with the above-discussed aspects are illustrated in FIGS. 1-16 and discussed herein. The erectable platforms are convertible between a collapsed configuration and an erected configuration. In the collapsed configuration, the erectable platforms are substantially flat, saving money in both packaging costs and shipping/storage costs. The erectable platforms can then be converted to the erected configuration to elevate a food product above a floor or tray of the microwave during the cooking cycle to promote more even microwave heating. The erectable platforms further include mechanisms to maintain the erectable platform in the erected configuration.

More particularly, the erectable platform includes a support for the food product during microwave heating thereof. In use, the support of the erectable platform supports the food product at least partially on a susceptor at a position elevated above a bottom floor or tray of a microwave. The susceptor provides for conductive heating of portions of the food product in contact therewith.

Legs elevate the support and connect to opposing edge portions of the support via hinges, such as fold lines, perforated fold lines and the like, which allow for rotation of the legs between the collapsed configuration and the erected configuration. In order to support the weight of the food product when in the erected configuration, the erectable platform includes mechanisms to maintain the erected configuration as well as support the weight of the food product and reduce bowing of the support, which are described with respect to the various embodiments below.

In the first exemplary embodiment illustrated in FIGS. 1-6, an erectable platform 100 is convertible between a collapsed configuration and an elevated configuration. The erectable platform 100 includes a support 102 for a food product 104 during microwave heating having a susceptor 106 thereon. The susceptor 106 may be disposed across all or part of the support 102. In the illustrated form, the support 102 is generally rectangular having a pair of side edge portions 108 and a pair of end edge portions 110.

First and second legs 112, 114 are connected to the support 102 to brace the support 102 and the food product 104 in an elevated position when the erectable platform 100 is in the erected configuration. In the illustrated form, the first and second legs 112, 114 are generally rectangular having a top edge 116, a bottom edge 118, and a pair of opposing side edges 120. The first and second legs 112, 114 are connected to the support 102 via first and second hinges 122, 124. Specifically, the first leg 112 is connected to the support 102 via the first hinge 122 adjacent one of the side edge portions 108 and the second leg 114 is connected to the support 102 via the second hinge 124 adjacent the other of the side edge portions 108. Alternatively, the first and second legs 112, 114 could connect to the support 102 adjacent the end edge portions 110. The first and second hinges 122, 124 may be any suitable rotational structure, such as fold lines or areas of weakness connecting the top edges 116 of the first and second legs 112, 114 to the support 102, tabs, such as a glue strip 126, adhered to the support 102 and connecting to the top edges 116 of the first and second legs 112, 114 via fold lines or other areas of weakness.

The erectable platform 100 may further include a base 128. The base 128 is generally rectangular having a pair of opposing side edge portions 130 and a pair of opposing end edge portions 132. The first and second legs 112, 114 connect to the side edge portion 130 of the base 128 via first and second hinges 134, 136. Alternatively, the first and second legs 112, 114 could connect to the base 128 adjacent the end edge portions 132. In use, the base 128 substantially maintains the first and second legs 112, 114 generally spaced a predetermined distance apart, restricting the legs from sliding outwardly or inwardly when the erectable platform 100 is in the erected configuration and supporting the food product 104. The first and second hinges 134, 136 may be any suitable rotational structure, such as fold lines or areas of weakness connecting the bottom edges 118 of the first and second legs 112, 114 to the base 128, tabs adhered to the base 128 and connecting to the bottom edges 118 of the first and second legs 112, 114 via fold lines or areas of weakness, or a combination of the two.

The collapsed configuration of the erectable platform 100 includes the first leg 112 being generally coplanar with the support 102, the second leg 114 being generally coplanar with the base 128, and the second leg 114 and the base 128 being generally parallel to the first leg 112 and the support 102. This substantially flat configuration can be utilized to save on packaging and shipping/storage costs while the erectable platform 100 still provides the benefit of elevated microwave heating of the food product 104.

When elevated, the erectable platform 100 defines open ends 138. The open ends 138 allow air flow underneath the support 102 and the susceptor 106 during microwave heating of the food product 104. This airflow can also work in conjunction with any suitable pattern or shape of vents 444, holes 446, cuts, perforations, etc. to allow for the ventilation of any excess moisture produced as a result of microwave heating the food product 104.

The erectable platform 100 further includes a support leg 140 configured to maintain the erectable platform 100 in the erected configuration, as well as support a portion of the support 102 inward from the side edge portions 108 and the end edges 110. In the illustrated form, the support leg 140 is formed of a first segment 142 of the first leg 112 and a second segment 144 of the second leg 114.

The first segment 142 is generally rectangular having a top edge 146, a bottom edge 148 and two side edges 150, however other configurations can be used. Preferably, the first segment 142 has a maximum height equal to the maximum height of the remainder of the first leg 112. One of the side edges 150 is connected to an adjacent portion of the first leg 112 via a first hinge 152. The first hinge 152 may extend partially or all the way between the top edge 116 and the bottom edge 118 of the first leg 112. By one approach, the first segment 142 is disposed horizontally intermediately within the first leg 112. More specifically, the first hinge 152 may be disposed at a middle portion of the first leg 112. Preferably, the first hinge 152 is generally transverse to and centered on the top and bottom edges 116, 118 of the first leg 112. By another approach, the first segment 142 may be disposed on one of the side edges 120 of the first leg 112.

The top edge 146 extends away from the first hinge 152 of the first segment 142 and along or adjacent the first hinge 122 connecting the support 102 and the first leg 112. Similarly, the bottom edge 148 extends away from the first hinge 152 of the first segment 142 and along or adjacent the first hinge 134 connecting the base 124 and the first leg 112. The side edge 150 opposite the first hinge 152 connects and is disposed generally transverse to the top and bottom edges 146, 148. The top edge 146, the bottom edge 148, and the side edge 150 opposite the first hinge 152 may include any suitable area of weakness, such as any pattern or configuration of single or multiple perforations, cuts, scores, thinned die lines, or the like. Alternatively, the top and bottom edges 146, 148 of the first leg 112 could extend from the first hinge 152 to one of the side edges 120 of the first leg 112, removing the need for an area of weakness for the side edge 150 opposite the first hinge 152.

Likewise, in the illustrated form, the second segment 144 is generally rectangular having a top edge 154, a bottom edge 156 and two opposing side edges 158, however other configurations can be used. Preferably, the second segment 144 has a maximum height equal to the maximum height of the remainder of the second leg 114. One of the side edges 158 is connected to an adjacent portion of the second leg 114 via a second hinge 160. The second hinge 160 may extend partially or all the way between the top edge 116 and the bottom edge 118 of the second leg 114. By one approach, the second segment 144 is disposed horizontally intermediately within the second leg 114. More specifically, the second hinge 160 may be disposed at a middle portion of the second leg 114. Preferably, the second hinge 160 is generally transverse to and centered on the top and bottom edges 116, 118 of the second leg 114. By another approach, the second segment 144 may be disposed on one of the side edges 120 of the second leg 114. Preferably, but not necessarily, the first hinge 152 of the first segment 142 is substantially aligned across the erectable platform 100 with the second hinge 160 of the second segment 144.

The top edge 154 extends away from the second hinge 160 of the second segment 144 and along or adjacent the second hinge 124 connecting the support 102 and the second leg 114. Similarly, the bottom edge 156 extends away from the second hinge 160 of the second segment 144 and along or adjacent the second hinge 136 connecting the base 124 and the second leg 114. The side edge 158 opposite the second hinge 160 connects and is disposed generally transverse to the top and bottom edges 154, 156. The top edge 154, the bottom edge 156, and the side edge 158 opposite the second hinge 160 may include any suitable area of weakness, such as any pattern or configuration of single or multiple perforations, cuts, scores, thinned die lines, or the like. Alternatively, the top and bottom edges 154, 156 of the second leg 114 could extend from the second hinge 160 to one of the side edges 120 of the second leg 114, removing the need for an area of weakness for the side edge 160 opposite the second hinge 160.

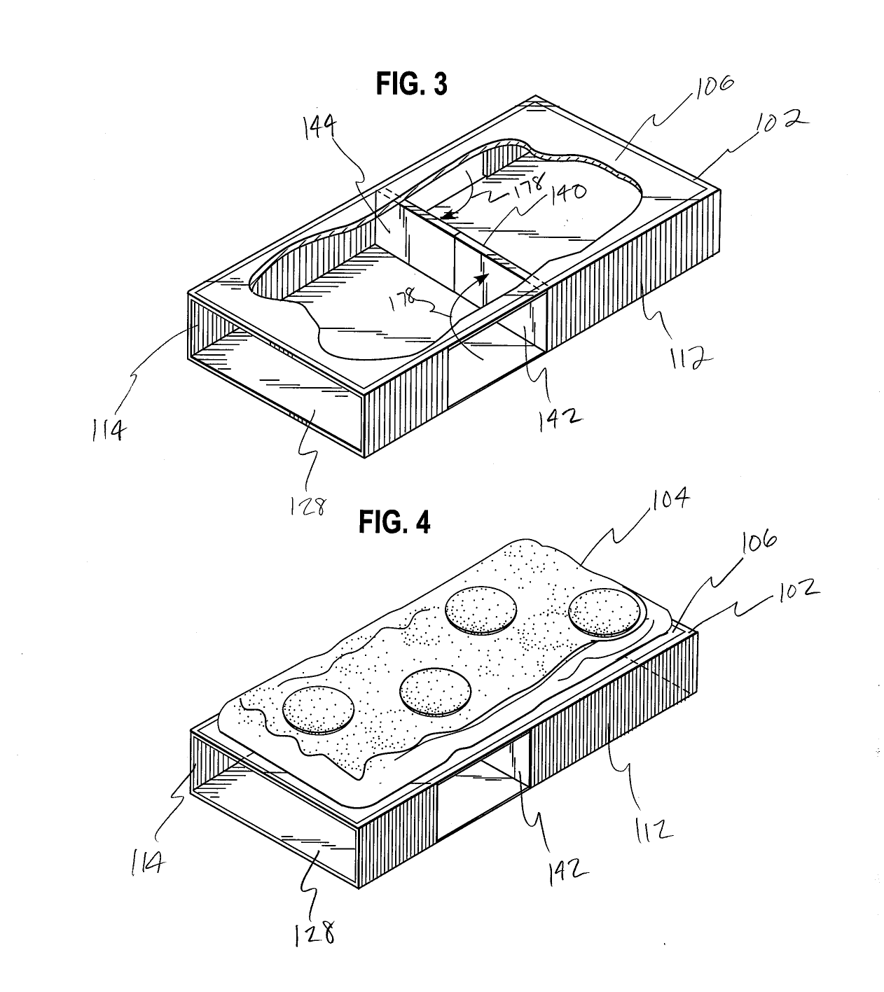

So configured, the first and second segments 142, 144 are inwardly movable about the first and second hinges 152, 160 to a position beneath the support 102 to contact an underside of the support 102 and maintain the erectable platform 100 in its erected configuration. In the illustrated form, the first and second hinges 152, 160 of the first and second segments 142, 144 are disposed generally horizontally centered within the first and second legs 112, 114 with the first and second segments 142, 144 extending in opposite directions. Preferably, the first and second segments 142, 144 have a length approximately equal to half of the width of the support 102 and the base 128. Accordingly, as shown in FIG. 3, when the first and second segments 142, 144 are moved to a position generally transverse to the first and second legs 112, 114, the first and second segments 142, 144 are generally continuous and coplanar, forming the support leg 140.

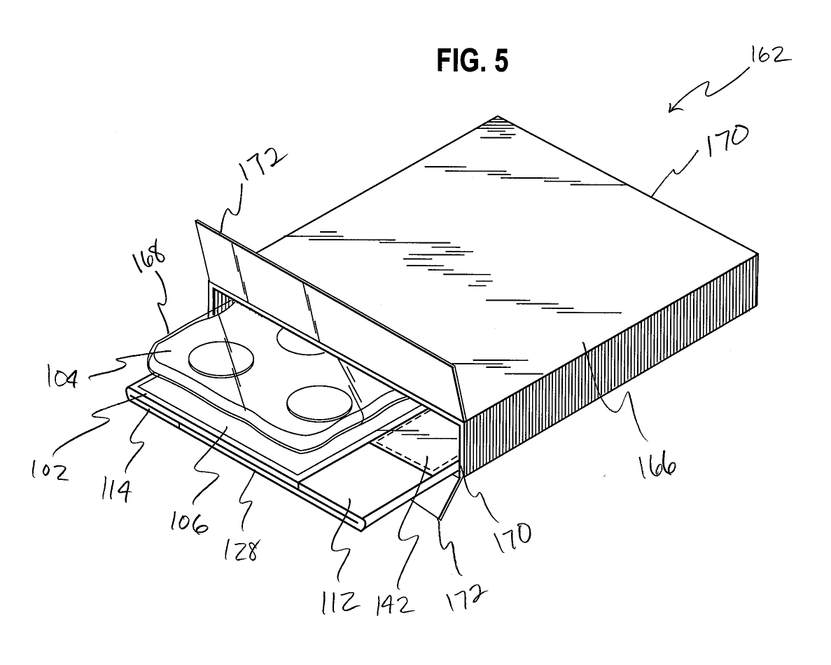

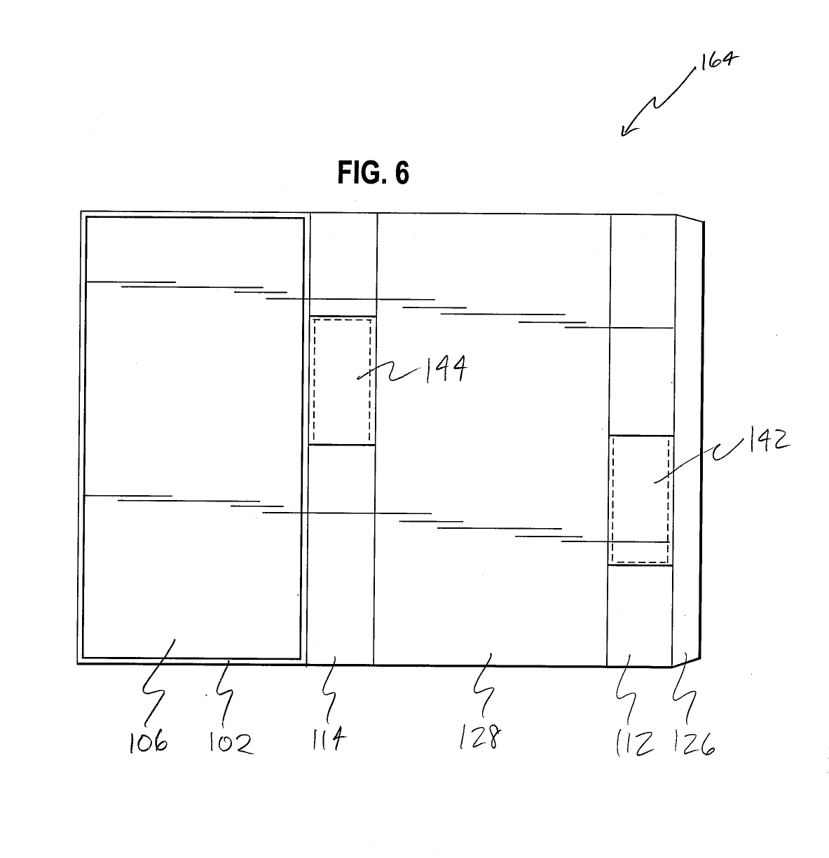

Referring now to FIGS. 5-6, the erectable platform 100 can be utilized as one part of a food product packaging 162. Preferably, though not necessarily, the erectable platform 100 is made from a single paperboard blank 164, as shown in FIG. 6. To initially form the erectable platform 100, any suitable adhesive is applied to the glue strip 126. Then the glue strip 126 is rotated about the first and second hinges 122, 124 connecting the support 102 to the first and second legs 112, 114 and the first and second hinges 134, 136 connecting the base 128 to the first and second legs 112, 114. Next, the glue strip is adhered to a bottom surface of the support adjacent the edge portion 108 adjacent the first leg 112. Once the glue strip 126 is secured, the erectable platform 100 is ready for the food product packaging 162.

The food product packaging 162 includes an outer carton 166, the food product 104 sealed within an inner film wrapper 168, and the erectable platform 100. Alternatively, the food product packaging 162 could include multiple food products 104 and/or multiple erectable platforms 100. In order to minimize the packaging costs of the outer carton 166, the erectable platform 100 can be packaged in its collapsed configuration saving on the material costs as a result of the reduced height of the outer carton 166. The food product 104 is wrapped within the inner film wrapper 168 as is known for preservation and protection. The food product 104 is then placed on top or below the erectable platform 100 and then the erectable platform 100 and the food product 104 are inserted into the outer carton 166. In one form, the outer carton 166 is formed of a paperboard blank having two ends 170 closed by folding over two pairs of opposing end flaps 172. It will be understood, however, that the outer carton 166 can be composed of other suitable materials, such as, cardboard, plastic, or metal, and that the outer carton 166 can be closed by other suitable methods, such as, hot sealing, cold sealing, or mechanically, by a locking tab or a tongue-and-groove mechanism.

So configured, the erectable platform 100 can be packaged with the food product 104 within the outer carton 166, shipped, and offered for sale in the collapsed configuration. In use, a user removes the erectable platform 100 from the outer carton 166 along with the food product 104. The user then converts the erectable platform 100 from the collapsed configuration, as shown in FIG. 1, to the erected configuration, as shown in FIG. 2. This can be done by first rotating the support 102 about the base 128, such as in a clockwise direction indicated by arrows 174, via the first and second hinges 122, 124 connecting the first and second legs 112, 114 to the support 102 and the first and second hinges 134, 136 connecting the first and second legs 112, 114 to the base 128 until the support 102 is generally aligned with the base 128 and supported by the first and second legs 112, 114. Then the user presses the first and second segments 142, 144 of the first and second legs 112, 114, respectively, to separate any areas of weakness connecting edges of the first and second segments 142, 144 to adjacent portions of the erectable platform 100. The first and second segments 142, 144 are then rotated inwardly, such as in directions indicated by arrows 176, 178, about the first and second hinges 152, 160 to a position beneath the support 102, where the first and second segments 142, 144 contact the support 102 and maintain the erectable platform 100 in its erected configuration. After converting the erectable platform 100 to its erected configuration, the user unwraps the food product 104 from the inner film wrapper 168, places the food product 104 onto the support 102, places the erectable platform 100 supporting the food product 104 into a microwave oven to be heated and/or cooked.

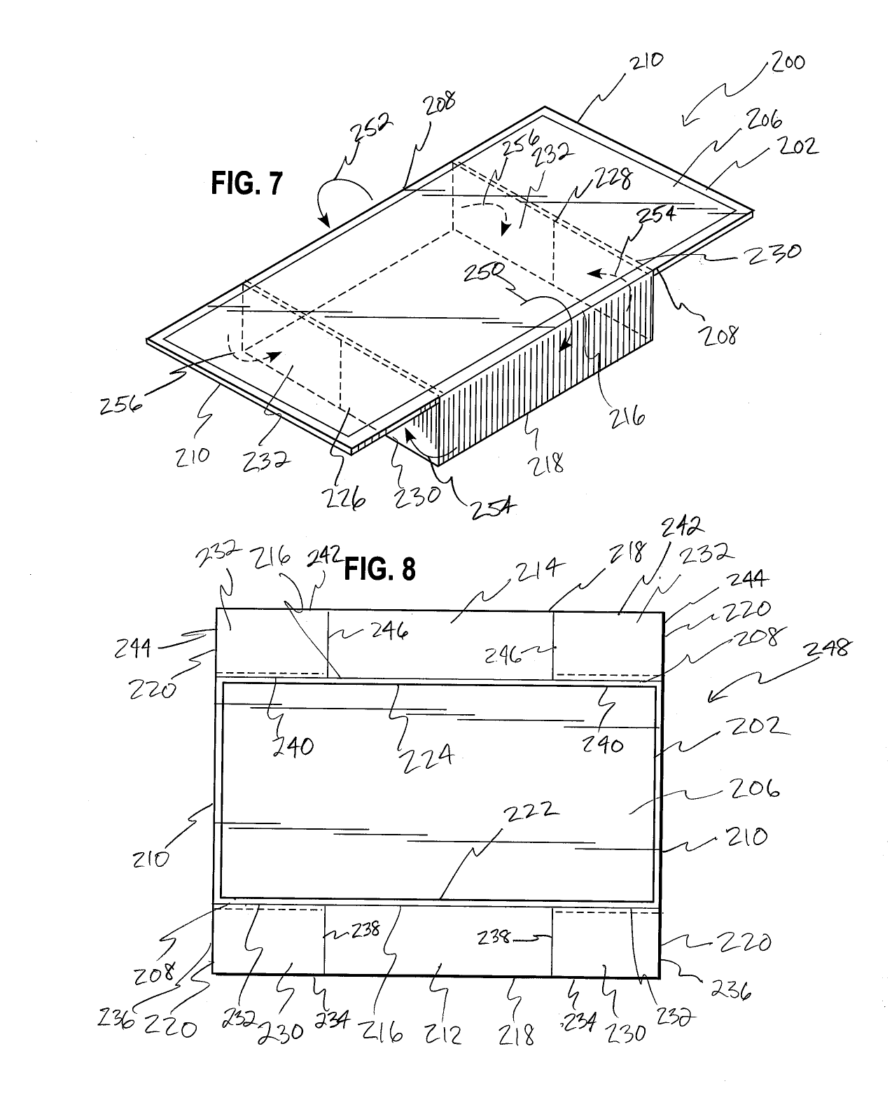

In the second exemplary embodiment illustrated in FIGS. 7-8, an erectable platform 200 is convertible between a collapsed configuration and an elevated configuration. The erectable platform 200 includes a support 202 for a food product 104 during microwave heating having a susceptor 206 thereon. The susceptor 206 may be disposed across all or part of the support 202. In the illustrated form, the support 202 is generally rectangular having a pair of opposing side edge portions 208 and a pair of opposing end edge portions 210.

First and second legs 212, 214 are connected to the support 202 to support the support 202 and the food product 104 in an elevated position when the erectable platform 200 is in the erected configuration. In the illustrated form, the first and second legs 212, 214 are generally rectangular having a top edge 216, a bottom edge 218, and a pair of opposing side edges 220. The first and second legs 212, 214 are connected to the support 202 via first and second hinges 222, 224. Specifically, the first leg 212 is connected to the support 202 via the first hinge 222 adjacent one of the side edge portions 208 and the second leg 214 is connected to the support 202 via the second hinge 224 adjacent the other of the side edge portions 208. Alternatively, the first and second legs 212, 214 could connect to the support 202 adjacent the end edge portions 210. The first and second hinges 222, 224 may be any suitable rotational structure, such as fold lines or areas of weakness connecting the top edges 216 of the first and second legs 212, 214 to the support 202, tabs, such as a glue strip, adhered to the support 202 and connecting to the top edges 216 of the first and second legs 212, 214 via fold lines or areas of weakness, or a combination of the two. In the illustrated form, the first and second legs 212, 214 have a length corresponding to the length of the edge portions 208 of the support 202.

The collapsed configuration of the erectable platform 200 includes the first leg 212 being generally coplanar with the second leg 214 and both the first leg 212 and the second leg 214 being generally parallel to the support 102. This substantially flat configuration can be utilized to save on packaging and shipping/storage costs while the erectable platform 200 still provides the benefit of elevated microwave heating of the food product 104.

When in the erected configuration, the erectable platform 200 can utilize any suitable pattern or shape of vents, holes, cuts, perforations, etc. to allow for the ventilation of any excess moisture produced as a result of microwave heating the food product 104 underneath the support 202.

The erectable platform 200 further includes first and second support legs 226, 228 configured to maintain the erectable platform 200 in the erected configuration, as well as support a portion of the support 202 inward from the side edge portions 208 and the end edges 210. In the illustrated form, the first and second support legs 226, 228 are formed from first segments 230 of the first leg 212 and second segments 232 of the second leg 214.

In the illustrated form, the first segments 230 are generally rectangular having a top edge 232, a bottom edge 234 and two side edges 236, however other configurations can be used. Preferably, the first segments 230 have a maximum height equal to the maximum height of the remainder of the first leg 212. For each of the first segments 230, one of the side edges 236 is connected to an adjacent portion of the first leg 212 via first hinges 238. The first hinges 238 may extend partially or all the way between the top edge 216 and the bottom edge 218 of the first leg 212. By one approach, the first segments 230 are disposed horizontally intermediately within the first leg 212. By another approach, one of the first segments 230 may be disposed on one of the side edges 220 of the first leg 212 and the other of the first segments 230 may be disposed horizontally intermediately within the first leg 212 adjacent the one of the first segments 230. By a third approach, the first segments 212 may be disposed on the side edges 220 of the first leg 212.

The top edges 232 extend away from the first hinges 238 of the first segments 230 and along or adjacent the first hinge 222 connecting the support 202 and the first leg 212, and preferably toward the adjacent side edges 220 of the first leg 212. The side edges 236 opposite the first hinges 238 connect and are disposed generally transverse to the top and bottom edges 232, 234. The top edges 232 and the side edges 236 opposite the first hinges 238 may include any suitable area of weakness, such as any pattern or configuration of single or multiple perforations, cuts, scores, thinned die lines, or the like. Alternatively, the top and bottom edges 232, 234 of the first leg 212 could extend from the first hinges 238 to the adjacent one of the side edges 220 of the first leg 212, removing the need for an area of weakness for the side edge 236 opposite the first hinges 238.

Likewise, in the illustrated form, the second segments 232 are generally rectangular having top edges 240, bottom edges 242 and two side edges 244, however other configurations can be used. Preferably, the second segments 232 have a maximum height equal to the maximum height of the remainder of the second leg 214. For each of the second segments 232, one of the side edges 244 is connected to an adjacent portion of the second leg 214 via second hinges 246. The second hinges 246 may extend partially or all the way between the top edge 216 and the bottom edge 218 of the second leg 214. By one approach, the second segments 232 are disposed horizontally intermediately within the second leg 214. By another approach, one of the second segments 232 may be disposed on one of the side edges 220 of the second leg 214 and the other of the second segments 232 may be disposed horizontally intermediately within the second leg 214 adjacent the one of the second segments 232. By a third approach, the second segments 214 may be disposed on the side edges 220 of the second leg 214. In the illustrated approach, the second segments 214 are substantially aligned with the first segments 230 across the support 202.

The top edges 240 extend away from the second hinges 246 of the second segments 232 and along or adjacent the second hinge 224 connecting the support 202 and the second leg 214, and preferably toward the adjacent side edges 220 of the second leg 214. The side edges 244 opposite the second hinges 246 connect and are disposed generally transverse to the top and bottom edges 240, 242. The top edges 240 and the side edges 244 opposite the second hinges 246 may include any suitable area of weakness, such as any pattern or configuration of single or multiple perforations, cuts, scores, thinned die lines, or the like. Alternatively, the top and bottom edges 240, 242 of the second leg 214 could extend from the second hinges 246 to the adjacent one of the side edges 220 of the second leg 214, removing the need for an area of weakness for the side edge 244 opposite the second hinge 246.

So configured, the first and second segments 230, 232 are inwardly movable about the first and second hinges 238, 246 to a position beneath the support 102 to contact the support 102 and maintain the erectable platform 100 in its erected configuration. Preferably, but not necessarily, the first and second hinges 238, 246 of the first and second segments 230, 232 are substantially aligned across the erectable platform 200. In the illustrated form, the first and second hinges 238, 246 of the first and second segments 230, 232 are disposed spaced from the side edges 220 of the first and second legs 212, 214 a distance approximately equal to half of the width of the support 102. Accordingly, as shown in FIG. 6, when the first and second segments 230, 232 are moved to a position generally transverse to the first and second legs 212, 214, the first and second segments 230, 232 are generally continuous and coplanar, forming the first and second support legs 226, 228 to maintain the erectable platform 200 in its erected configuration.

As discussed with reference to FIG. 5 for the first embodiment, the erectable platform 200 can be utilized as one part of the food product packaging 162. Preferably, through not necessarily, the erectable platform 200 is made from a single paperboard blank 248, as shown in FIG. 8. The food product packaging 162 includes the outer carton 166, the food product 104 sealed within the inner film wrapper 166, and the erectable platform 200. In order to minimize the packaging costs of the outer carton 166, the erectable platform 200 can be packaged in its collapsed configuration. The food product 104 is wrapped within the inner film wrapper 166 as is known for preservation and protection and placed on top or below the erectable platform 200. Alternatively, the food product 104 and the erectable platform 200 can both be packaged within the inner film wrapper 166. The erectable platform 200 and the food product 104 are then inserted into the outer carton 166. Advantageously, due to the collapsed configuration of the erectable platform 200 having the legs 212, 214 folded underneath the support 202, the outer carton 166 can be sized to fit the width and length of the support 202, which can be sized to closely match the width of the food product 104. This configuration minimizes the material necessary to package the erectable platform 200 in its collapsed configuration and the food product 104 within the outer carton 166.

So configured, the erectable platform 200 can be packaged with the food product 104 within the outer carton 166, shipped, and offered for sale in the collapsed configuration. In use, a user removes the erectable platform 200 from the outer carton 166 along with the food product 104. The user then converts the erectable platform 200 from the collapsed configuration to the erected configuration, as shown in FIG. 7. This is done by first rotating the first and second legs 212, 214 about the support 202, such as in directions indicated by arrows 250, 252, via the first and second hinges 222, 224 connecting the first and second legs 212, 214 to the support 202, until the first and second legs 212, 214 are generally perpendicular to the support 202. Then the user presses the first and second segments 230, 232 of the first and second legs 212, 214, respectively, to separate any areas of weakness connecting edges of the first and second segments 230, 232 to adjacent portions of the erectable platform 200. The first and second segments 230, 232 are then rotated inwardly, such as in directions indicated by arrows 254, 256, about the first and second hinges 238, 246 to a position beneath the support 202, where the first and second segments 230, 232 contact the support 202 and maintain the erectable platform 200 in its erected configuration. After converting the erectable platform 200 to its erected configuration, the user unwraps the food product 104 and places the food product 104 onto the support 202. The use then places the erectable platform 200 and the food product 104 upon a floor or tray of a microwave for microwave heating and/or cooking

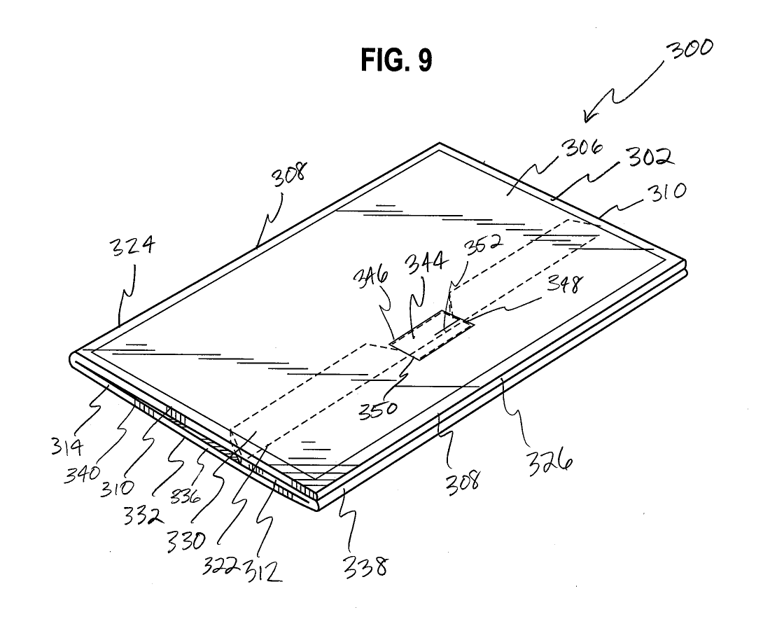

In the third exemplary embodiment illustrated in FIGS. 9-13, an erectable platform 300 is convertible between a collapsed configuration and an elevated configuration. The erectable platform 300 includes a support 302 for a food product 104 during microwave heating having a susceptor 306 thereon. The susceptor 306 may be disposed across all or part of the support 302. In the illustrated form, the support 302 is generally rectangular having a pair of opposing side edge portions 308 and a pair of opposing end edge portions 310.

First and second legs 312, 314 are connected to the support 302 to support the support 302 and the food product 104 in an elevated position when the erectable platform 300 is in the erected configuration. In the illustrated form, the first and second legs 312, 314 are generally rectangular having top edges 316, bottom edges 318, and pairs of opposing side edges 320. The first and second legs 312, 314 are connected to the support 302 via first and second hinges 322, 324. Specifically, the first leg 312 is connected to the support 302 via the first hinge 322 adjacent one of the side edge portions 308 and the second leg 314 is connected to the support 302 via the second hinge 324 adjacent the other of the side edge portions 308. In the illustrated form, the first leg 312 is offset from a side edge 326 of the support 302 by a predetermined distance, such as the height of the first and second legs 312, 314, creating an overhang 328.

The first and second hinges 322, 324 may be any suitable rotational structure, such as fold lines or areas of weakness connecting the top edges 316 of the first and second legs 312, 314 to the support 302, tabs, such as a glue strip 330, adhered to the support 302 and connecting to the top edges 316 of the first and second legs 312, 314 via fold lines or areas of weakness, or a combination of the two.

The erectable platform 300 may further include a base 332. The base 332 is generally rectangular having a pair of side edge portions 334 and a pair of end edge portions 336. The first and second legs 312, 314 connect to the side edge portion 334 of the base 332 via first and second hinges 338, 340. In use, the base 332 substantially maintains the first and second legs 312, 314 spaced a predetermined distance apart, restricting the legs 312, 314 from sliding outwardly or inwardly when the erectable platform 300 is in the erected configuration and supporting the food product 104. The first and second hinges 338, 340 may be any suitable rotational structure, such as fold lines or areas of weakness connecting the bottom edges 318 of the first and second legs 312, 314 to the base 332, tabs adhered to the base 332 and connecting to the bottom edges 318 of the first and second legs 312, 314 via fold lines or areas of weakness, or a combination of the two.

The collapsed configuration of the erectable platform 300, as shown in FIG. 8, includes the second leg 314 being generally coplanar with the base 328, the first leg 312 being generally parallel with the second leg 314 and the base 328, and the support 302 being generally parallel with the first leg 312 and the second leg 314 and the base 328. This substantially flat configuration can be utilized to save on packaging and shipping/storage costs while the erectable platform 300 still provides the benefit of elevated microwave heating of the food product 104.

When elevated, the erectable platform 300 defines open ends 342. The open ends 342 allow air flow underneath the support 302 and the susceptor 306 during microwave heating of the food product 104. This airflow can also work in conjunction with any suitable pattern or shape of vents 444, holes 446, cuts, perforations, etc. to allow for venting of any excess moisture produced as a result of microwave heating of the food product 104 underneath the support 302.

The erectable platform 300 further includes a locking tab 344. The locking tab 344 is formed within the perimeter of the support 302. In the illustrated form, the locking tab 344 is generally rectangular having two side edges 346 and two end edges 348. The locking tab 344 is movable about a hinge 350 connected to one of the end edges 348 and to an adjacent portion of the support 302 to a position generally transverse to the support 302. Preferably, the locking tab 344 has a height approximately equal to the height of the first and second legs 312, 314 so that the locking tab 344 contacts the base 332 and/or the floor of the microwave to provide additional support for the support 302 and the food product 104. The two side edges 348 and the end edge 348 opposite the hinge 350 can be defined by any suitable area of weakness, such as any pattern or configuration of single or multiple perforations, cuts, scores, thinned die lines, or the like.

The locking tab 344 is aligned with the first leg 312 and moves about the hinge 350 to interlock with the first leg 312 to maintain the erectable platform 300 in its erected configuration. Specifically, the locking tab 344 includes a separable portion 352 into which the first leg 312 is configured to be inserted as the locking tab 344 is rotated to a position generally transverse to the support 302 to secure the first leg 312 and restrict the erectable platform 300 from rotating from the erected configuration to the collapsed configuration. Alternatively, the locking tab 344 could be aligned and interlock with the second leg 314

Further, the first leg 312 may define a removed portion 354 having two side edges 356 and a bottom edge 358. The removed portion 354 spaces the area of the first leg 312 that inserts into the separable portion 352 downward, which allows the separable portion 352 of the locking tab 344 to extend only part of the longitudinal length of the locking tab 344, increasing the structural strength of the locking tab 344. The removed portion 354 extends through the glue strip 330 onto a portion of the first leg 312. Preferably, the side edges 356 of the removed portion 354 extend into the first leg 312 generally perpendicular to the top edge 316 of the first leg 312. The bottom edge 358 of the removed portion 354 may be angled away from the hinge 350 of the locking tab 344, such as at an angle in the range of 1 to 15 degrees, and preferably about 7 degrees. This angle facilitates inserting the first leg 312 into the separable portion 352.

As discussed with reference to FIG. 5 for the first embodiment, the erectable platform 300 can be utilized as one part of the food product packaging 162. Preferably, though not necessarily, the erectable platform 300 is made from a single paperboard blank 360, as shown in FIG. 13. To initially form the erectable platform 300, any suitable adhesive is applied to the glue strip 330. Then the glue strip 330 is rotated about the first and second hinges 322, 324 connecting the support 302 to the first and second legs 312, 314 and the first and second hinges 338, 340 connecting the base 332 to the first and second legs 312, 314. Next, the glue strip 330 is adhered to a bottom surface of the support 302 adjacent the edge portion 308 adjacent the first leg 312. In the illustrated form, the glue strip 330 is offset from the side edge 326 of the support 302 by the predetermined distance. Once the glue strip 330 is secured, the erectable platform 300 is ready for the food product packaging 162.

The food product packaging 162 includes the outer carton 166, the food product 104 sealed within the inner film wrapper 168, and the erectable platform 300. In order to minimize the packaging costs of the outer carton 166, the erectable platform 300 can be packaged in its collapsed configuration. The food product 104 is wrapped within the inner film wrapper 168 as is known for preservation and protection. The food product 104 is then placed on top or below the erectable platform 300 and then the erectable platform 300 and the food product 104 are inserted into the outer carton 166. Advantageously, due to the collapsed configuration of the erectable platform 300 having the legs 312, 314 and the base 328 folded underneath the support 302, the outer carton 166 can be sized to fit the width and length of the support 302, which can be sized to closely match the width of the food product 104. This configuration minimizes the material necessary to package the erectable platform 300 in its collapsed configuration and the food product 104 within the outer carton 166.

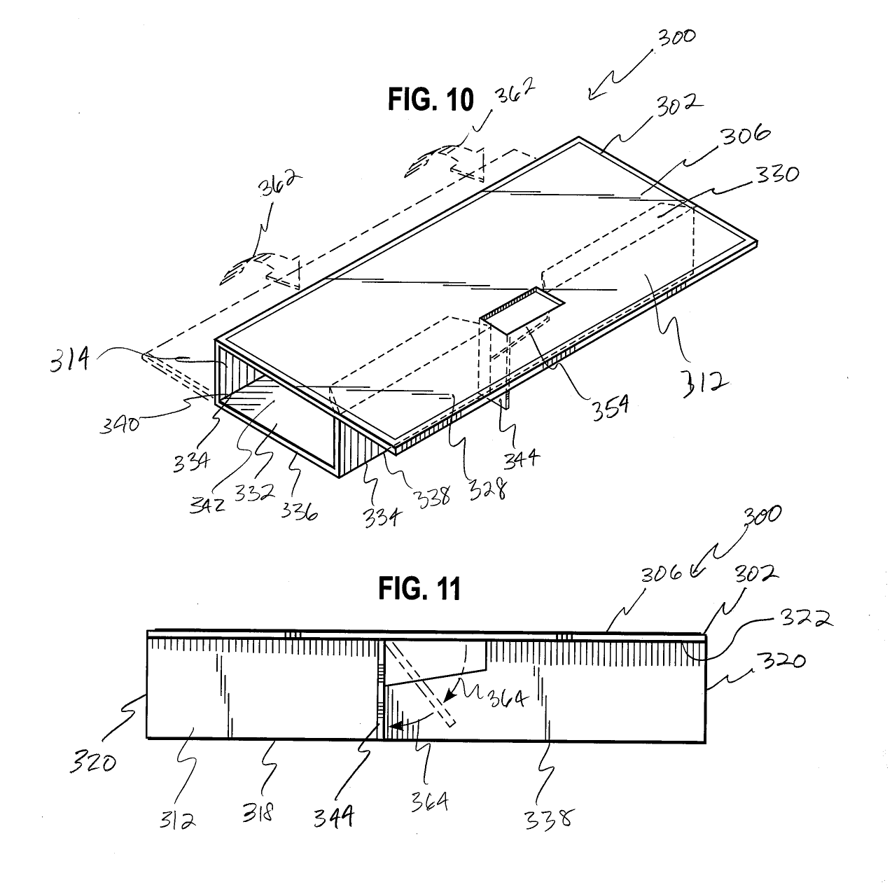

So configured, the erectable platform 300 can be packaged with the food product 104 within the outer carton 166, shipped, and offered for sale in the collapsed configuration. In use, a user removes the erectable platform 300 from the outer carton 166 along with the food product 104. The user then coverts the erectable platform 300 from the collapsed configuration, as shown in FIG. 9, to the erected configuration, as shown in FIGS. 10-12. This is done by first rotating the support 302 about the base 332, such as in a clockwise direction indicated by arrows 362, via the first and second hinges 322, 324 connecting the first and second legs 312, 314 to the support 302 and the first and second hinges 338, 340 connecting the first and second legs 312, 314 to the base 332 until the support 302 is generally aligned with the base 332 and supported by the first and second legs 312, 314. Then the user presses the locking tab 344 to separate any areas of weakness connecting edges of the locking tab 344 to adjacent portions of the support 302. The locking tab 344 is then rotated downwardly, such as in a direction indicated by arrows 364, about the hinge 350 to a position beneath the support 302, where the first leg 312 inserts into the separable portion 352 of the locking tab 344. The locking tab 344 then reaches a position generally transverse to the support 302 to maintain and support the erectable platform 300 in its erected configuration. After converting the erectable platform 300 to its erected configuration, the user unwraps the food product 104 and places the food product 104 onto the support 302. The user then places the erectable platform 300 supporting the food product into a microwave for microwave heating and/or cooking

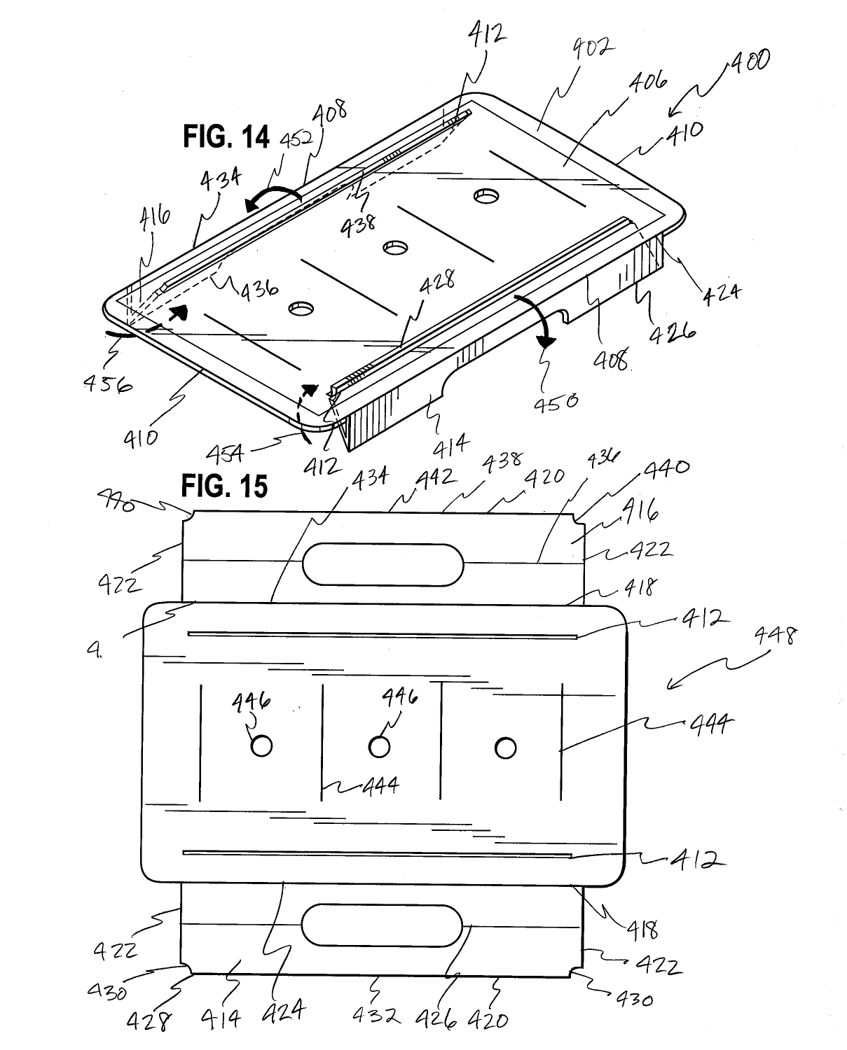

In the fourth exemplary embodiment illustrated in FIGS. 14-16, an erectable platform 400 is convertible between a collapsed configuration and an elevated configuration. The erectable platform 400 includes a support 402 for a food product 104 during microwave heating having a susceptor 406 thereon. The susceptor 406 may be disposed across all or part of the support 402. In the illustrated form, the support 402 is generally rectangular having a pair of opposing side edge portions 408 and a pair of opposing end edge portions 410. The support 402 further includes at least one slot 412 disposed adjacent each of the side edge portions 408.

First and second legs 414, 416 are connected to the support 402 to support the support 402 and the food product 104 in an elevated position when the erectable platform 400 is in the erected configuration. In the illustrated form, the first and second legs 414, 416 are generally rectangular having a top edge 418, a bottom edge 420 to the top edge 418, and a pair of opposing side edges 422.

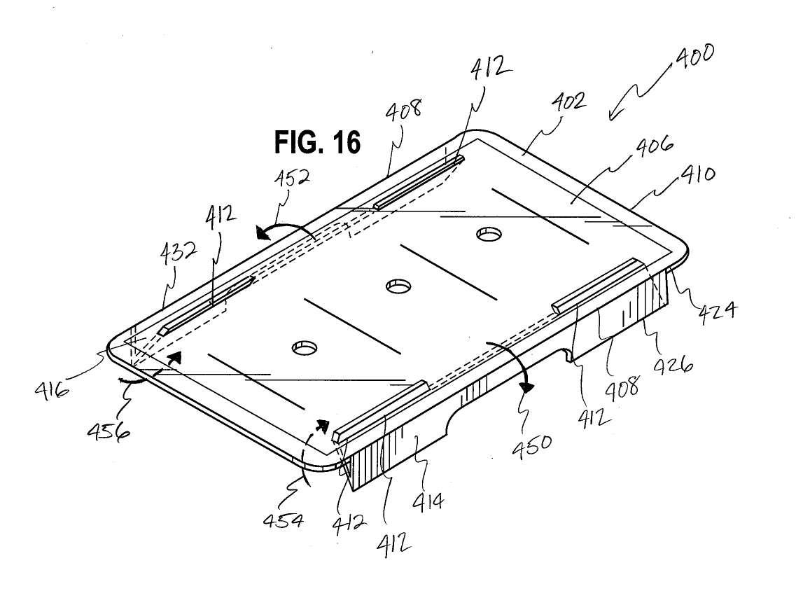

The first leg 414 connects to the support 402 via a first hinge 424 adjacent one of the side edge portions 408. The first leg 414 further includes a second hinge 426 disposed between the first hinge 424 and the bottom edge 420 of the first leg 414. In the illustrated form, the second hinge 426 is disposed generally transverse to the side edges 422 of the first leg 414. The bottom edge 420 of the first leg 414 includes at least one protruding tab 428. In the illustrated form, the protruding tab 428 has a pair of side edges 430 that are, in the illustrated form, opposing concavely arcuate and a top edge 432. The protruding tab 428, however, can take other suitable shapes, as long as the top edge 432 has a width less than an adjacent area, such as side edges 430 that are angled, as shown in FIG. 16.

Likewise, the second leg 416 connects to the support 402 via the first hinge 434 adjacent one of the side edge portions 408. The second leg 416 further includes a second hinge 436 disposed between the first hinge 434 and the bottom edge 420 of the second leg 416. In the illustrated form, the second hinge 436 is disposed generally transverse to the side edges 422 of the second leg 416. The bottom edge 420 of the second leg 416 includes at least one protruding tab 438. In the illustrated form, the protruding tab 438 has a pair of opposing side edges 440 that are, in the illustrated form, concavely arcuate and a top edge 442. The protruding tab 438, however, can take other suitable shapes, as long as the top edge 442 has a width less than an adjacent area.

The first hinges 424, 434 of the first and second legs 414, 416 may be any suitable rotational structure, such as fold lines or areas of weakness connecting the top edges 418 of the first and second legs 414, 416 to the support 402, tabs, such as a glue strip, adhered to the support 402 and connecting to the top edges 418 of the first and second legs 414, 416 via fold lines or areas of weakness, or a combination of the two. Similarly, the second hinges 426, 436 of the first and second legs 414, 416 can also be any suitable rotational structure connecting adjacent portions of the first and second legs 414, 416.

The collapsed configuration of the erectable platform 400 includes the first leg 414 being generally coplanar with the second leg 416 and both the first leg 414 and the second leg 416 being generally parallel to the support 402. This substantially flat configuration can be utilized to save on packaging and shipping/storage costs while the erectable platform 400 still provides the benefit of elevated microwave heating of the food product 104.

When in the erected configuration, the erectable platform 400 can utilize any suitable pattern or shape of vents 444, holes 446, cuts, perforations, etc. to allow for venting of any excess moisture produced as a result of microwave heating of the food product 104 underneath the support 402.

As discussed with reference to FIG. 5 for the first embodiment, the erectable platform 400 can be utilized as one part of the food product packaging 162. Preferably, though not necessarily, the erectable platform 400 is made from a single paperboard blank 448. The food product packaging 162 includes the outer carton 166, the food product 104 sealed within the inner film wrapper 168, and the erectable platform 400. In order to minimize the packaging costs of the outer carton 166, the erectable platform 400 can be packaged in its collapsed configuration. The food product 104 is wrapped within the inner film wrapper 168 as is known for preservation and protection. The food product 104 is then placed on top or below the erectable platform 400 and then the erectable platform 400 and the food product 104 are inserted into the outer carton 166.

So configured, the erectable platform 400 can be packaged with the food product 104 within the outer carton 166, shipped, and offered for sale in the collapsed configuration. The erectable platform 400 can be converted from the collapsed configuration to the erected configuration, as shown in FIGS. 14 and 16. This can be done by folding the first leg 414 about the support 402 via the first hinge 424, indicated by arrow 450, and the second hinge 426, indicated by arrow 452, and inserting the at least one protruding tab 428 into the at least one slot 412 adjacent the side edge portion 408 adjacent the first leg 414. The second leg 416 can be folded about the support 402 via the first hinge 434, indicated by arrow 454, and the second hinge 436, indicated by arrow 456, and the at least one protruding tab 438 can be inserted into the at least one slot 412 adjacent the side edge portion 408 adjacent the second leg 416. In an alternative form, the support 402 includes a plurality of the slots 412 disposed adjacent each of the side edge portions 408 and the first and second legs 414, 416 include a plurality of protruding tabs 438, which can then be inserted into the plurality of the slots 412.

In the illustrated forms, the support is generally rectangular having four sides. In use, however, the support may take any suitable shape, including, for example, curvilinear shapes, such as generally circular or elliptical, or shapes with linear sides, such as a triangle, a quadrilateral, a hexagon, an octagon, or other regular or irregular polygons. The susceptor may be imprinted onto the support or, alternatively, may be secured to the support by any suitable method, such as adhesive. The susceptor may be of a type that expands upon heating to better conform to an adjacent portion of the food product, which can be advantageous if the adjacent portion of the food product has surface irregularities or is slightly curved, and thus not entirely planer. One type of expanding susceptor material is made and sold by Graphics Packaging, Inc. under the product name QuiltWave™. As the susceptor expands, it can at least partially contact some of the non-planar portions of the adjacent portion of a food product resulting in a more desirable food product.

The separable raised platforms disclosed herein are particularly suitable for use with food products having an outer dough-based portion in contact with the susceptor surface. For example, the separable raised platforms can be used in microwave heating of a food product that comprises French bread having toppings, such a pizza toppings, and an outer crust on the bottom. Other examples of food products having dough-based portions include sandwiches, calzones, pitas, pizzas, strombolis and other such dough-enrobed or dough-based food products. The dough-based portions of the food products can be in various forms, such as cooked, par-baked, raw, ready-to-heat, ready-to-eat, proofed or unproofed dough which is suitable for being cooked, browned, and/or crisped.

Preferably, though not necessarily, the separable raised platforms are formed from a single unitary blank of material, such as paperboard. Forming the separable raised platforms from a single unitary blank can eliminate the need for separately attaching the legs to the support.

The drawings and the foregoing descriptions are not intended to represent the only forms of the separable raised platform in regards to the details of construction. Changes in form and in proportion of parts, as well as the substitution of equivalents, are contemplated as circumstances may suggest or render expedient.

What is claimed is:

1. A platform for microwave heating of a food product convertible between a collapsed configuration and an erected configuration to permit elevated microwave heating of a food product, the platform comprising:
a support for the food product during microwave heating thereof, the support having a pair of edge portions;
a susceptor disposed on the majority of the support for conducting heat to a food product thereon during microwave heating; and
a pair of legs, one of the legs connected to the support via a hinge adjacent one of the edge portions of the support and the other of the legs connected to the support via a hinge adjacent the other of the edge portions, each of the legs having a segment inwardly movable about a hinge at a middle portion of the leg to a position beneath the support generally aligned with the segment of the other leg to contact an underside of the support across a middle portion thereof and maintain the platform in its erected configuration.

2. The platform of claim 1 wherein a base is connected via hinges to each of the legs opposite the susceptor and in the collapsed configuration of the erectable platform one of the legs and the support are generally coplanar and the other of the legs and the base are coplanar and generally parallel to the one of the legs and the support.

3. A platform for microwave heating of a food product convertible between a collapsed configuration and an erected configuration to permit elevated microwave heating of a food product, the platform comprising:
a support for the food product during microwave heating thereof, the support having a pair of edge portions;
a susceptor disposed on the majority of the support for conducting heat to a food product thereon during microwave heating; and
a pair of legs, one of the legs connected to the support via a hinge adjacent one of the edge portions of the support and the other of the legs connected to the support via a hinge adjacent the other of the edge portions, each of the legs having at least one segment at an end thereof inwardly movable about a hinge with an adjacent portion of the leg to a position beneath the support and spaced from an edge of the support to contact an underside of the support and maintain the platform in its erected configuration.

4. The platform of claim 3 wherein each of the legs has a segment at each end thereof inwardly movable about a hinge with an adjacent portion of the leg to a position beneath the support and spaced from an edge of the support to contact the underside of the support and maintain the platform in its erected configuration.

5. The platform of claim 4 wherein the two segments of the legs are each generally about half a width of the support.

6. The platform of claim 3 wherein in the collapsed configuration of the erectable platform comprises the legs are generally parallel to the support.

7. A platform for microwave heating of a food product convertible between a collapsed configuration and an erected configuration to permit elevated microwave heating of a food product, the platform comprising:
a support for the food product during microwave heating thereof, the support having a pair of opposing edge portions;
a susceptor disposed on the majority of the support for conducting heat to a food product thereon during microwave heating;
a pair of legs, one of the legs connected to the support via a hinge adjacent one of the edge portions of the support and the other of the legs connected to the support via a hinge adjacent the other of the edge portions; and
wherein the support further comprises a segment movable about a hinge with an adjacent portion of the support to an interlocking position with one of the legs to maintain the platform in its erected configuration.

8. The platform of claim 7 further comprising a base, wherein the base is connected to bottom edges of the legs to substantially maintain the bottom edges spaced a predetermined distance apart.

9. The platform of claim 8 wherein in the collapsed configuration of the erectable platform the legs and the base are generally parallel to the other of the legs and the support.

10. The platform of claim 7 wherein the segment has a height approximately equal to a height of the erectable platform in the erected configuration to provide additional support for the support.

11. The platform of claim 7 wherein at least three sides of the segment are defined by areas of weakness.

12. The platform of claim 7 wherein the one of the legs and the segment are offset from an edge of the support.

13. The platform of claim 7 wherein the segment includes an edge opposite the hinge with the adjacent portion of the support and a slit extended from the edge for receiving a portion of the one of the legs in the interlocking position.

14. The platform of claim 13 wherein edges of the segment other than adjacent the hinge are defined by areas of weakness between the segment of the adjacent portion of the support.

15. The platform of claim 14 wherein a base is connected to bottom edges of the legs to substantially maintain the bottom edges spaced a predetermined distance apart.

16. The platform of claim 15 wherein the one of the legs and the segment are offset from an edge of the support.

17. A platform for microwave heating of a food product convertible between a collapsed configuration and an erected configuration to permit elevated microwave heating of a food product, the platform comprising:
a support for the food product during microwave heating thereof, the support having a pair of opposing edge portions and at least one slot adjacent each of the edge portions, a susceptor disposed on the majority of the support for conducting heat to a food product thereon during microwave heating, the support free from structure above the susceptor such that it is generally planar; and
a pair of legs each having a top edge and a bottom edge, one of the legs connected to one of the pair of opposing edge portions of the support and the other of the legs connected to the other of the pair of opposing edge portions of the support, each of the legs including:
a first hinge disposed between the leg and the associated one of the edge portions of the support, and
a second hinge disposed between the first hinge and the bottom edge,
wherein the legs are configured to fold about the first hinge, fold about the second hinge, and wherein at least part of the bottom edge of each leg is configured to be insertable into an adjacent one of the slots of the support to secure the platform in its erected position with the legs depending therefrom and the platform supported in the erected position by the second hinge.

18. The platform of claim 17 wherein in the collapsed configuration of the erectable platform comprises the legs are generally parallel to the support.

19. The platform of claim 17 wherein there are a plurality of slots provided in the susceptor surface adjacent each of the edge portions each for receiving a part of the bottom edge of the adjacent leg.

20. A platform for microwave heating of a food product convertible between a collapsed configuration and an erected configuration to permit elevated microwave heating of a food product, the platform comprising:
a support for the food product during microwave heating thereof, the support having a pair of edge portions;
a susceptor disposed on the majority of the support for conducting heat to a food product thereon during microwave heating;
a pair of legs, one of the legs connected to the support via a hinge adjacent one of the edge portions of the support and the other of the legs connected to the support via a hinge adjacent the other of the edge portions; and
wherein at least one of the pair of legs is spaced from the adjacent edge portion of the support by a distance substantially equal to or greater than the height of the one of the pair of legs, so that when in the collapsed configuration, the width of the platform is substantially equal to the width of the support.

21. The platform of claim 20 further comprising a base connecting edges of the pair of legs opposite the support.

22. The platform of claim 20 in combination with an outer carton, wherein the outer carton has a width and length approximately equal to the support and a depth approximately equal to the height of the food product and the erectable platform in the collapsed configuration.
